(19) United States
(12) Patent Application Publication
(10) Pub. No.: US 2008/0186558 A1
(43) Pub. Date: Aug. 7, 2008

(54) TWO DIMENSIONAL LIGHT CONTROL FILM

(76) Inventors: Jong-Seo Lee, Yongin-City (KR); Yongchan Ahn, Seoul (KR); Margaret M. Vogel-Martin, Forest Lake, MN (US); Gary E. Gaides, Woodbury, MN (US)

Correspondence Address: 3M INNOVATIVE PROPERTIES COMPANY, PO BOX 33427, ST. PAUL, MN, 55133-3427, US

(21) Appl. No.: 11/672,243

(22) Filed: Feb. 7, 2007

(51) Int. Cl. G02B 26/02

(52) U.S. Cl. 359/227

(57) ABSTRACT

According to the invention, a light control film has a first matrix section comprising a polymer material which is at least partially opaque and has a film-like shape. Within this film are a plurality of second sections, which are of a pillar type, and are formed completely through a thickness direction of the film. In a second embodiment of the invention, a light control film has a first matrix section comprising a polymer material and having a film-like shape. Within this film are a plurality of second sections, which are at least partially opaque and are of a pillar type formed completely through a thickness direction of the film.

### TECHNICAL FIELD OF THE INVENTION

The present invention is directed to a light control film. In particular, the present invention is directed to a two dimensional light control film having a light control effect in at least two directions of the film, and a process of manufacturing the same.

### BACKGROUND OF THE INVENTION

A light control film is a kind of optical film that prevents off-axis leakage of light transmitted therethrough by controlling the propagation directions of the transmitted light within a specific angle range. A conventional light control film is a so-called louver film (100), in which polymer film layers with relatively high (101) optical density and polymer film layers with relatively low optical density (102) are alternatively arranged and fixed to each other (see FIG. 1).

Uses for such light control films are lenses and goggles, which are worn where high levels of illumination or glare are encountered. The film may also be used for transparent covering of a backlighted instrument panel, such as the instrument panel of an automobile, to minimize reflections from the windshield. A light control film may also be used to give a black and white photographic negative the appearance of a positive made from the negative.

Light control films have been widely used as a privacy filter for optical display devices such as liquid crystal display device (also referred to as a “LCD” device).

In general, an LCD device comprises a liquid crystal panel and a light source, i.e. a backlight, which illuminates the liquid crystal panel from the back surface (i.e. the surface opposite of the display surface). For the backlight, an edge-light or direct-lit type backlight can be used. However, in the case of illumination by such conventional backlights, since the light beam is directly transmitted through the liquid crystal panel toward a viewer of the display and the display can be seen by a person standing at an angle apart from the viewer, guarding the privacy of the display is difficult, e.g., with an automated teller machine (ATM), the user's PIN number may be viewable by another person. Furthermore, when the LCD device is an automobile-loaded equipment, such as a car navigation system, the reflection from the panel of the LCD device on the windshield may interfere with the vision of the driver.

To solve these problems, the display panel can be equipped with a light control film that prevents the unnecessary propagation of light emitted by the liquid crystal panel in directions away from the viewing axis.

A light control film can be employed as an external light-shielding layer in a PDP filter. The light control film comprises a plurality of wedge-shaped black stripes arranged parallel to each other at a surface of a matrix made of a transparent resin. The black stripes are formed with a light-absorbing material. Thus they reduce external light from coming into the PDP panel assembly. As a result, they enhance the contrast ratio of the PDP device under a bright room condition.

A light control film having “louvers” can be produced by skiving a billet consisting of alternating plastic layers having a relatively low optical density (transparent) and a relatively high optical density (colored). When the billet is skived, the colored layers provide louver-form elements, which collimate the light beam. These elements can extend in the direction perpendicular to the surface of the light control film.

To produce the louver layer,a layer containing the light-shielding material is fixed to one main surface of a polymer film used as the light-transmitting part to form the louver-form elements, resulting in a laminate film consisting of the polymer film and the light-shielding material layer. A plurality of such laminate films are prepared and laminated to form a precursor louver film, in which the polymer film and the light-sheilding material layers are alternately arranged and fixed to each other. The precursor louver film is skived at a desired thickness along the direction (lamination direction) perpendicular to the main surface (laminated plane) to obtain the louver layer.

Conventional louver type films are one-dimensional light control films, i.e. they have a light control effect only to the right and left (or up and down) of the film. A single sheet of conventional louver film thus cannot meet the user's need to ensure security in all directions including right-and-left and up-and-down of the film. In addition, in case of a light control film used for shielding the external light in a PDP filter, it does not sufficiently control the light up and down of the film. In order to achieve a light control effect in various directions by a conventional light control film, two films should be overlapped with their louver directions crossing each other. However, this inevitably results in the problem of increasing the film thickness and decreasing the light transmittance.

### SUMMARY OF THE INVENTION

According to the invention, a light control film has a first matrix section comprising a polymer material which is at least partially opaque and has a film-like shape. Within this film are a plurality of second sections, which are of a pillar type, and are formed completely through a thickness direction of the film.

In a second embodiment of the invention, a light control film has a first matrix section comprising a polymer material and having a film-like shape. Within this film are a plurality of second sections, which are at least partially opaque and are of a pillar type formed completely through a thickness direction of the film.

### BRIEF DESCRIPTION OF THE DRAWINGS

FIG. 1 is a schematic view of a conventional light control film comprising louver elements.

FIG. 2a is a schematic view representing one embodiment of the light control film according to the present invention.

FIGS. 2b-2g are cross sectional views of the second pillar sections representing embodiments of the present invention.

FIGS. 3a-3c are cross sectional views partially representing the light control film of the present invention,

FIGS. 4a-4c are schematic views showing a cross section and planes of the light control film of the present invention.

FIGS. 5a-5c are schematic views showing a cross section and planes of the light control film of the present invention.

FIG. 6 is a cross sectional view of the film composite formed by laminating the protective substrates on and beneath a light control film of the present invention.

FIGS. 7a and 7b show embodiments in which optically transparent members are disposed in the matrix during the process of manufacturing the light control film of the present invention.

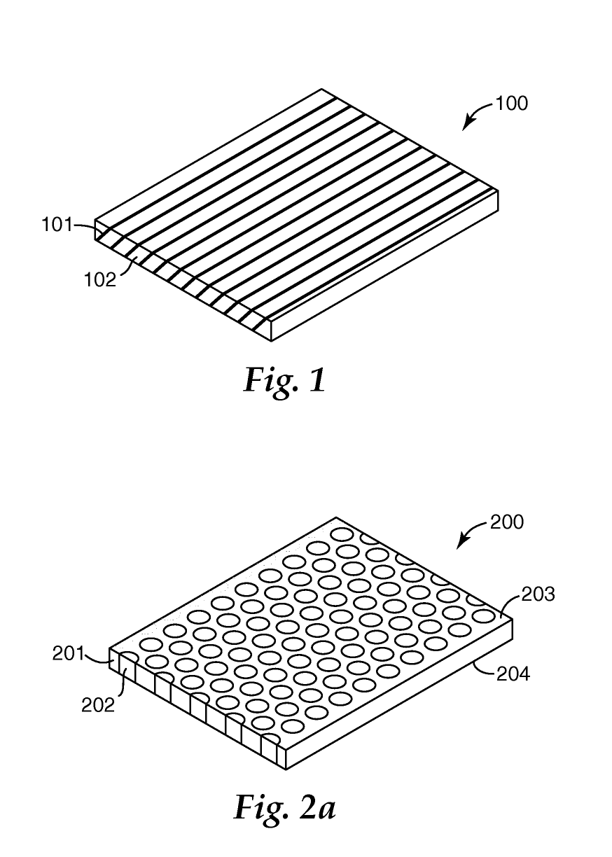

### DETAILED DESCRIPTION OF THE INVENTION

The present invention is directed to a new light control film that overcomes the limits of conventional ones. The present invention suggests a totally different concept in providing the structure of a light control film. The two dimensional light control film of the present invention controls the viewing angle from more than two directions of the film by employing the new structure wherein a plurality of slim transparent sections having a pillar shape are disposed through the matrix film. The two dimensional light control effect occurs because the propagation of the light components incident from the back side of the film are restricted by the inside wall of the transparent section when the light passes through the transparent section of a pillar. One embodiment of the current invention achieves multi-directional filtering with the same cut-off angle for all potential viewing angles (up-and-down, right-and-left, and any intermediary position). Furthermore, the multi-directional filtering takes place with use of only one film.

In the present specification, the term “two dimensional light control” means that the viewing angle of a film is controlled from more than two independent directions, e.g. four directions or all directions of the film layer.

Terms such as “optically transparent,” “transparent,” or “transmitting the light” means that the light is transmitted to the extent acceptable to the light transmitting portions of the conventional louver type light control film at the desired wavelengths.

Terms such as “optically opaque,” “opaque” or “not transmitting the light” means that the light is absorbed and/or diffused (or dispersed) to the extent acceptable to the opaque portions (light-shielding portions) of the conventional louver type film at the desired wavelengths.

Terms such as “different opacity” can encompass variations from transparent to some level of acceptable opacity as well as from some level of acceptable opacity to another level of acceptable opacity at the desired wavelengths.

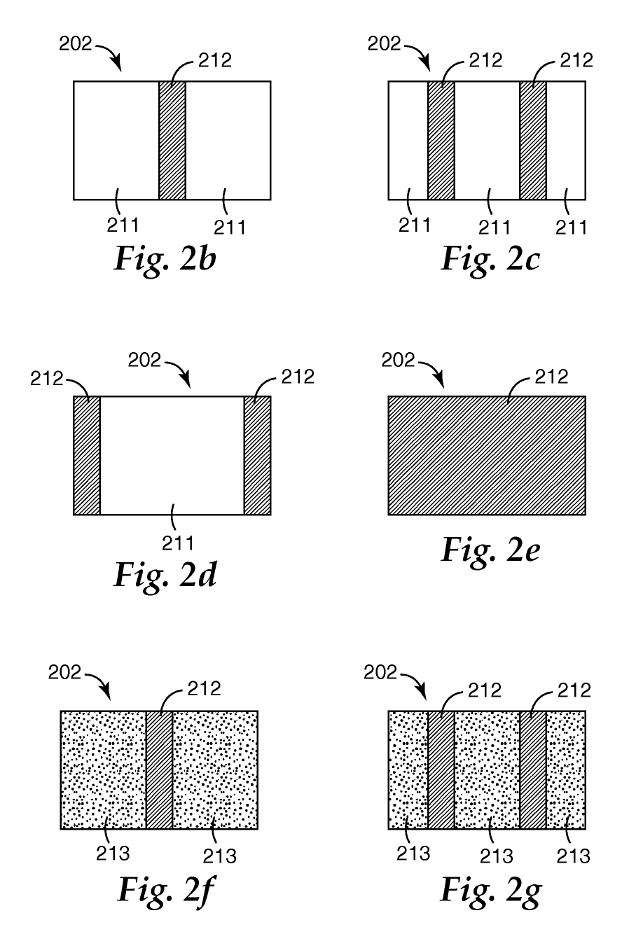

The constitution of the light control film of the present invention is described in detail hereinafter. FIG. 2a shows the two dimensional film (200) of the present invention includes: a first section having a film-like shape (201), and a plurality of the optically transparent second sections (202), which are of a pillar type formed through a thickness direction of the film. The term “thickness direction” herein means the direction along which light passes, i.e. the direction from the upper surface (203) to the lower surface (204) of the film (200). It should be noted that thickness direction does not necessarily need to be perpendicular to these two surfaces.

The first section (201), together with the second sections (202), takes a film-like shape and may consist of optically transparent or opaque material. The second sections (202) having a slim pillar shape are disposed in the first section (201) through the thickness direction. The second sections (202) comprise optically transparent material. Alternatively, the second sections (202) may comprise optically transparent regions (211) and optically opaque layers (or regions) (212) as shown in FIGS. 2(b), (c) and (d). In another alternative embodiment, the second sections (202) are optically opaque, as shown in FIG. 2(e). Alternatively, as shown in FIGS. 2(f) and (g), second sections (202), comprise optically opaque regions (212) adjacent to a second opaque layer (213) with different opacity than (212). The first section (201) and the second sections (202) may consist of the same or different material.

In one embodiment, the pillars disposed in the first section of the light control film are parallel to each other. The term “parallel” for the pillars means that the main axes connecting the center of the gravity of the upper surface and the lower surface of the pillar are parallel to each other. The pillars formed in the first section are preferably disposed perpendicularly to the upper and the lower surfaces of the film. However, the pillars may be slanted relative to the upper or the lower surface as necessary, for example when there is a need to adjust the viewing angle of the film. The “perpendicular” pillar has a main axis parallel to the normal axis of the upper or lower surface of the film.

The cross section of the pillar cut perpendicularly to its main axis may be a circle, an oval or a polygon such as triangle, tetragon, pentagon, hexagon, etc. The cross section cut along the main axis of the pillar is usually a rectangle. However, it may be a tetragon such as trapezoid or have at least one curved side. The shape of the pillar can be modified or selected by those skilled in the art considering the control of the optical properties including viewing angle or transmittance, or manufacturing convenience. In view of these, the pillar preferably has a cylindrical shape.

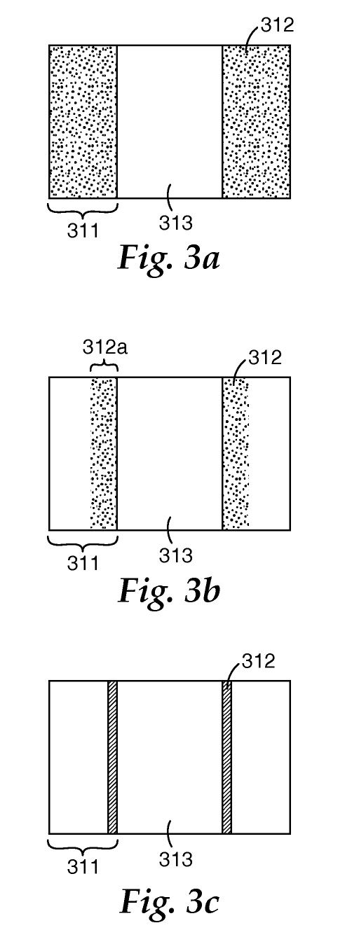

The outer side of the second section having the pillar shape and consisting of the transparent material may be partially or totally coated with an opaque material (see FIG. 3c). The opaque material (or the section not transmitting the light) prevents the propagation of the light beam out of the optically transparent sections. The opaque material used in the present invention may be a substance commonly employed in the manufacture of an optical film to form the opaque area. The material absorbs, reflects or diffuses the light (the wavelengths of light in the current variation are typically in the visible range of the electromagnetic spectrum), and in some embodiments includes (i) dark pigments or dark dyes such as black or gray pigments or dyes, (ii) metal such as aluminum, silver, etc., (3) dark metal oxides, and (4) dark pigments or dark dyes dispersed in a suitable binder. Carbon black is typically used.

The basic material consisting of the first section of the present invention may be any transparent or opaque material commonly used for an optical film in the art. When the basic material for the first section is transparent, the first section may show an opaque property by containing any of the aforementioned opaque materials. A suitable material for the first section may be a natural or synthetic polymer including a thermoplastic resin, a thermosetting resin, or a resin curable with an actinic ray such as UV. More specific examples of such resins include cellulose resins (e.g. cellulose acetate butyrate and triacetylcellulose), polyolefin resins (e.g. polyethylene and polypropylene), polyester resins (e.g. polyethylene terephthalate), polystyrene, polyurethane, polyvinyl chloride, acrylic resins, and polycarbonate resins. In one embodiment cellulose resins are used.

FIGS. 3a-3c are cross sectional views partially representing the light control film of the present invention, in which an opaque material is distributed uniformly in the first section, densely around the second section, and as coated about the external surface of the second section. FIGS. 3a-3c show that an opaque material (312) may be uniformly added into the first section (311) (see FIG. 3a). Otherwise, opaque material (312) may be added into certain layers (or regions or parts) 312a, with varying density (i.e. that have gradated opacity). For example, one can consider adding an opaque material (312) densely around the optically transparent second section (313) (see FIG. 3b).

The optically transparent second section may be made by processing the same or different material as the first section into a slim pillar shape. However, polymer fiber is preferably used for the second section. The polymer fiber may be made from any of the optically transparent material listed above as suitable for the first section. Preferably, the polymer fiber is polymethylmetacrylate (PMMA) or acryl fiber. In addition, the second sections may consist of optical fibers commonly used in the art, such as silicate-based, fluorine-based, rare earth element-based, plastic-based and plastic cladding optical fibers. By using ready-made and commercially available fiber type material, the manufacturing step for forming the second sections can be omitted, and thus the overall process for making the light control film is simplified. In addition, the size of the transparent section can be easily controlled by selecting the appropriate size of the fiber. It is also possible to control the optical properties of the transparent section according to the kind of material of the fiber.

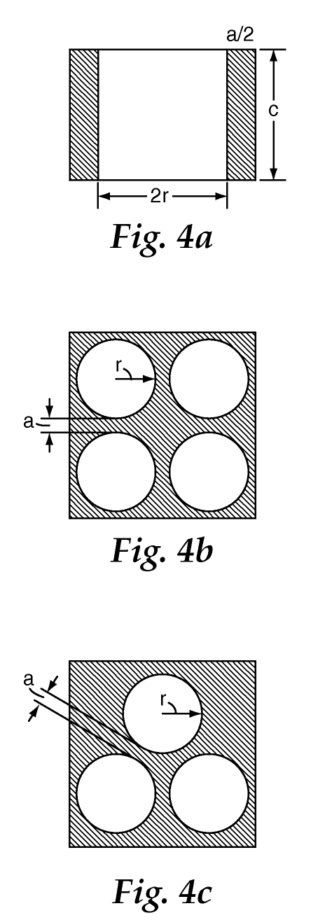

Optical properties that should be taken into consideration when preparing the light control film, such as transmittance and viewing angle, can be controlled by adjusting the size of the second section. FIGS. 4a-4c are a partial cross sectional view and partial plane views showing the two dimensional light control film in which the first and the second sections are optically opaque and transparent, respectively. When the cylindrically shaped second section has radius “r,” thickness “c,” shortest distance between the adjacent two cylinders “a” and refractive index “n,”(“n” is a refractive index of the second section) transmittances (T) of the films like FIGS. 4b and 4c can be represented by following formulas, respectively:

$$T = \frac{π {r}^{2}}{{( 2 r + a )}^{2}} {\{ \frac{4 n}{{( 1 + n )}^{2}} \}}^{2}$$

$$T = \frac{2 π {r}^{2}}{\sqrt{3} {( 2 r + a )}^{2}} {\{ \frac{4 n}{{( 1 + n )}^{2}} \}}^{2}$$

In above cases, the viewing angle of each light control film can be represented as following formula:

$$Viewing angle = 2 arcsin \{ \frac{2 nr}{\sqrt{4 {r}^{2} + {c}^{2}}} \}$$

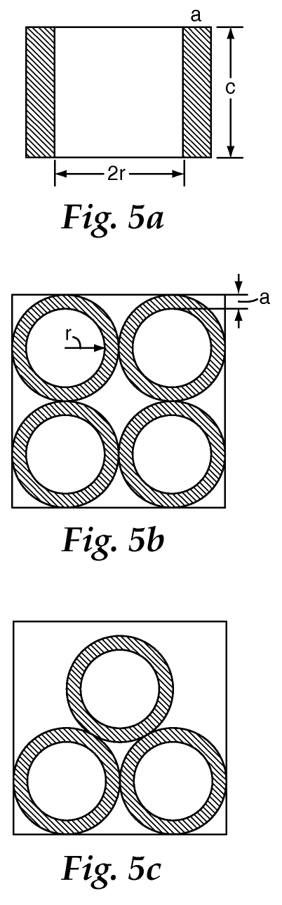

FIGS. 5a-5c show another type of two dimensional light control film comprising optically transparent first and the second sections, and an opaque material coating the second section. When the cylindrically shaped second section has radius “r,” thickness “c,” width of the coated material “a” and refractive index “n,” transmittances (T) of the films like FIGS. 5b and 5c can be represented by following formulas, respectively:

$$T = \{ 1 - \frac{π a ( 2 r + a )}{4 {( r + a )}^{2}} \} \cdot {\{ \frac{4 n}{{( 1 + n )}^{2}} \}}^{2}$$

$$T = \{ 1 - \frac{π a ( 2 r + a )}{2 \sqrt{3} {( r + a )}^{2}} \} {\{ \frac{4 n}{{( 1 + n )}^{2}} \}}^{2}$$

In above cases, the viewing angles of the films are also as follows:

$$Viewing angle = 2 arcsin \{ \frac{2 nr}{\sqrt{4 {r}^{2} + {c}^{2}}} \}$$

The thickness of the light control film of the present invention is preferably 10 to 1000 μm, more preferably 10 to 500 μm, and most preferably 100 to 300 μm. When the film is too thin, the light control effect can not be achieved since the viewing angle of the film is excessively large. On the contrary, a film that is too thick produces an excessively narrow viewing angle and can reduce transmittance.

Adding opaque material as described in the present invention to the first matrix and or second pillar sections can have the effect of changing the refractive index of the material. For example carbon black, a common opacifier, has a relatively high index of refraction compared to common polymers used in light control film (as described herein).

When the index of refraction of the first matrix (e.g opaque material) and second pillar sections (e.g. transparent material) is different, light is reflected at the interface between the two. The effect of this reflection is the creation of “ghost” images. The percentage of the incident light that is reflected increases with increasing angle of incidence and increasing difference of index of refraction. For these purposes the angle of incidence is the angle between the ray of light and a normal to the interface between the first matrix and second pillar sections. As a result, the ghost images of a typical light control film are most noticeable at angles between 5° and 25° from the axis of the pillars. Such ghost images are aesthetically displeasing, at best.

To reduce reflections at the transparent and opaque material interface, it may be desirable to match or nearly match the index of refraction of the transparent material with the index of refraction of the opaque material over all or a portion of the visible spectrum. Reducing such reflections tends to reduce the formation of ghost images. It can often be difficult to index match materials over a significant range of wavelengths such as the entire visible spectrum, and in these cases it can be desirable to use an opaque material that has an index of refraction that is equal to or slightly greater than the index of refraction of the transparent material over the spectral range of interest (e.g. over the range of visible wavelengths).

Referring now to FIGS. 2(a)-(f), the ghosting effect may be minimized or, perhaps, eliminated through manipulation of the layer distributions and refractive indexes of the various sections and layers (201), (202), (211), (212) and (213). If the optically opaque region (212) in the second section (202) has a refractive index nearly identical to the optically transparent first section (201), then the optically transparent region (211) in the second section may be optionally omitted (e.g. see FIG. 2(e) or included (e.g. see FIGS. 2(b), (c) and (d)). In the latter instance, the refractive index of the optically transparent region (211) shall be nearly identical to the optically transparent first section (201) and the optically opaque region (212) of the second section. If the refractive index of the optically opaque region (212) is substantially different from that of the optically transparent first section (201), then the effect of ghosting may be reduced by introducing, in the second sections, an optically transparent region (211) that has a refractive index that is intermediary between the two sections/regions (201) and (212) (e.g. see FIGS. 2(b), (c) and (d)). This refractive index gradient can be achieved through the proper selection of materials for the optically transparent region (211). Alternatively, the optically transparent region (211) in the second section may be replaced by an optically opaque region (213) (e.g. see FIGS. 2(f) and (g)). As discussed above, by varying the amount of opaque material in the optically opaque region (213) the refractive index of region (213) can be selected to be intermediary between the refractive index of sections/regions (201) and (212). Similarly, this selection of an intermediary refractive index can occur in the first section 311 (or matrix) portion of the current invention, such as in region 312a shown in FIG. 3b.

Referring again to FIG. 4, when the second section is cylindrically shaped, the shortest distance between the adjacent cylinders is preferably 1 to 100 μm, more preferably 1 to 50 μm and most preferably 1 to 20 μm. The volume of the opaque section of the film increases in proportion to the distance between the cylinders. Thus, too great a distance between the cylinders reduces the transmittance of the light control film. Referring again to FIGS. 5b and 5c, in one embodiment the opaquely coated pillars of the second section are in direct contact with their nearest neighbors. This is particularly useful when the first matrix section is transparent, since it prevents zones where no privacy would occur.

When the second section is cylindrically shaped, the radius of the cylinder is preferably 1 to 300 μm, more preferably 1 to 150 μm and most preferably 1 to 75 μm. The transmittance of the film increases as the radius of the cylinder. However, too large a radius compared to the film thickness cannot produce the desirable light control effect since the viewing angle increases accordingly.

A two dimensional light control film according to the present invention produces a constant viewing angle regardless of the observed direction. When the light control film having cylindrical second sections has a film thickness of 150 μm, the distance between the cylinders of 3.5 μm and the cylinder radius of 27 μm, a constant viewing angle of about 61° results regardless of the viewing direction.

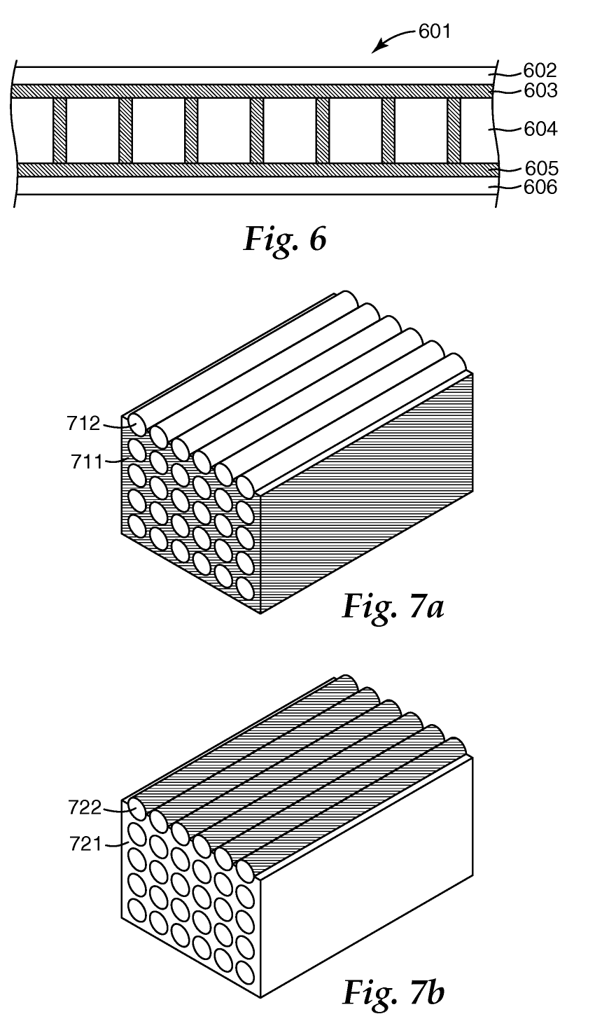

A composite light control film can be manufactured by laminating at least one protective substrate on, beneath or, on and beneath of the aforementioned two dimensional light control film. The protective substrate may be one commonly used in the art to protect a conventional light control film. As shown by FIG. 6, the two dimensional light control film composite (601) has the two dimensional light control film (604) and the backside substrate (606) and the surface side substrate (602). The substrates (602) and (606) are fixed to the light control film layer (604) with the permanent adhesive layers (603) and (605). Preferably, the material of each substrate (602) or (606) and each permanent adhesive layer (603) or (605) have as high a transparency as possible.

The two substrates (602) and (606) are preferably installed on or beneath the light control film (604), since they suppress the warp or curl of the light control film (604) and in turn the warp or curl of the film composite (601) comprising the light control film. The surface side substrate (602) also functions as a protective layer that protects the light control film layer (604) from damage.

The substrates (602) and (606) are usually formed of polymer sheets. For polymers of the polymer sheets, those having no bond containing an oxygen atom in the backbone, three-dimensionally crosslinked polymers or crystalline polymers are preferable. The three-dimensionally crosslinked polymers or crystalline polymers are less thermally decomposed than uncrosslinked polymers or amorphous polymers. Examples of polymers of the substrates include polycarbonates, polyesters (e.g. polyethylene terephthalate, polyethylene naphthalate, etc.) acrylic polymers, vinyl chloride polymers, crystalline polyurethane (e.g. polycarbonate base polyurethane, etc.) and the like.

Permanent adhesive layers (603) and (605) may be formed of a conventional adhesive such as a pressure-sensitive adhesive, a heat-sensitive adhesive, a curable adhesive, etc. In general, the adhesive comprises a self-adherent polymer, which is preferably crosslinked. A self-adherent polymer means a polymer that exhibits tackiness at room temperature (about 25 ° C.).

The self-adherent polymer of the permanent adhesive layers are preferably those having no bond containing an oxygen atom in the backbone, and may be, for example, an acrylic polymer, a nitrile-butadiene copolymer (e.g. NBR, etc.), a styrene-butadiene copolymer (e.g. SBR, etc.), an amorphous polyolefin, etc. The self-adherent polymer may comprise one or more of these polymers.

The protective substrates (602) and (606) may be treated to have matte or glossy properties. The substrates may also be treated to have any special property such as antistatic property, antireflective property, antiglare or hardcoat properties, if necessary.

An exemplary process for manufacturing a fiber for use as the second sections of a plurality of light transmitting members having a pillar shape is set forth hereinafter. A multilayer concentric fiber may be fabricated using the following process. For brevity and clarity, this description exemplifies the process with a transparent polymer and opaque polymer. However, as discussed previously, the two polymers could also be of different opacity. A filament consisting of alternating concentric rings of a transparent polymer and an opaque polymer may be produced m)□ by using a die that consists of shims that are each 0.005 inch (125 thick. Two shims produce a ring so a 4 shim die would produce a filament consisting of 2 rings. One half of these rings would be the transparent polymer and the other half would be the opaque polymer. This die would have two inlet ports; one for the molten transparent polymer and one for the molten opaque polymer.

The transparent polymer could be selected from cellulose resins (e.g. cellulose acetate butyrate and triacetylcellulose), polyolefin resins (e.g. polyethylene and polypropylene), polyester resins (e.g. polyethylene terephthalate), polystyrene, polyurethane, polyvinyl chloride, acrylic resins, and polycarbonate resins. The opaque polymer could be the same resin or a different resin than the selected transparent resin with carbon black, pigment or other absorbing material added as the opacifier.

The number of layers formed is controlled by varying the number of shims in the die and by varying process conditions such as flow rate and temperature. The design of the shims in the stack can be varied to adjust the thickness profile of the fiber rings. The shims in the spinneret pack may be formed using laser-cutting.

Solidified pellets of the two polymers may be separately fed to one of two twin screw extrudes. These extruders may be operated at temperatures ranging from 260° C.-300° C. and at screw speeds ranging from 40-70 rpm. Typical extrusion pressures may range from about 2.1×10⁶ Pa to about 2.1×10⁷ Pa. Each extruder may be equipped with a metering gear pump which could supply a precise amount of molten polymer to the filament spinning die. The size of each metering gear pump may be 0.16 cc/revolution and these gear pumps may generally be operated at identical speeds ranging from 10-80 rpm. The molten polymer may be transferred from the metering pumps to the die using heated, stainless steel neck tubes.

The molten polymer streams would enter the die and flow through the shims. The first shim pair creates the core of the filament, the second shim pair forms the first ring around the core, a third shim pair forms the second ring on the outside of the first ring. This molten, multi-ring filament then exits the die and is quenched in a tank of water. The filament is drawn into the water using a pull roll. The filament exits the pull roll and is wound onto a core using a level winder. The combination of the metering pump speed and the wind speeds controls the diameters of the filament. Typical speeds for this process can range from about 0.5 ms⁻¹-4 ms⁻¹.

In an alternative embodiment, Torayca™ carbon fiber, available from Toray, Inc. or Pyron™ carbon fiber available from Zoltek, Corp. with individual fiber diamteres ranging from 4-10 microns may be used as the second section (202) of the light control film.

An exemplary process for manufacturing the two dimensional light control film of the present invention is set forth hereinafter. The manufacturing process of the present invention comprises the principal steps for forming the first section of the matrix and the second sections of a plurality of light transmitting members having a pillar shape to be separately present to each other. For example, the steps may comprise appropriately disposing the solid light transmitting members into the fluidal matrix. As another example, a method of addressing electric field can be considered when at least one of the materials of the first or the second sections has electric conduction properties.

More particularly, the process for manufacturing the two dimensional light control film of the present invention comprises the steps of:

(a) providing a curable matrix,

(b) immersing a plurality of a pillar type second section material into said matrix,

(c) curing said matrix, and

(d) skiving the resulting composite.

The skiving may occur perpendicular to or at an angle to the major axis of the pillars.

The above curable matrix consists of the film-like shaped first section. The curable matrix may be one commonly used in the art for manufacturing an optical film, such as a thermosetting resin, or a resin curable with an actinic ray such as UV. The second section materials, which are already mentioned above, constitute the second sections.

The manufacturing process may comprise the further step of coating the light transmitting members with opaque material in order to form the light-shielding coat restricting the passage of the transmitted light beam. In addition, opaque material may be added to the curable matrix. The opaque material can be added into the whole of the curable matrix uniformly. However, it is also possible to add the opaque material with varying density in certain areas, such in the case of the light transmitting members. Any one or both of coating and adding opaque material can be done to make the light shielding region as necessary.

One method of forming a plurality of the light transmitting members having a pillar shape into the matrix is immersing the members, for example polymer fibers, into the curable polymer resin in a fluidal state, followed by curing the polymer resin. For example, FIG. 7a shows that the cylindrically shaped light transmitting members (712) are immersed at a fixed distance between the cylinders in the curable matrix (711) containing the opaque material. FIG. 7b shows that the cylindrically shaped light transmitting members (722) coated with the opaque material are immersed at a fixed distance between the cylinders in the curable matrix (721). The light transmitting members are appropriately disposed in the fluidal matrix at a desired distance. Then, the matrix is cured.

After the composite of the matrix and the light transmitting members is sufficiently cured, the two dimensional light control film is obtained by skiving a part of the composite. The skived film may be trimmed as necessary. The light control film composite may be formed by laminating the protective substrate on and/or beneath the two dimensional light control film.

The two dimensional light control film of the present invention has the effect of restricting the viewing angle in all directions of the film layer. It thus guarantees security when applied as a privacy filter. In addition, when the light control film is used in a PDP filter, it enhances the contrast ratio of the PDP panel under a bright room condition by shielding the external light in the all directions.

Further to the above, according to conventional methods, it was necessary to overlap at least two louver type light control films to achieve the two dimensional light control effect, while only one film is necessary in the present invention. As such, the new type of light control film of the present invention provides two dimensional light control effect without increasing the film thickness or decreasing light transmittance.

1. A light control film comprising:
a first matrix section comprising a polymer material which is at least partially opaque and has a film-like shape, and
a plurality of second sections, which are of a pillar type formed completely through a thickness direction of the film.

2. A light control film comprising:
a first matrix section comprising a polymer material having a film-like shape, and
a plurality of second sections which are at least partially opaque and are of a pillar type formed completely through a thickness direction of the film.

3. The light control film of claim 2, wherein the plurality of second sections are opaque throughout each second section.

4. The light control film of claim 2, wherein the first matrix section is optically transparent throughout the first matrix section.

5. The light control film of claim 1 or 2, wherein each pillar of the second section is perpendicular to an upper surface and lower surface of the film.

6. The light control film of claim 1 or 2, wherein each pillar of the second sections has a cylindrical shape.

7. The light control film of claim 1 or 2, wherein the second sections comprise polymer fibers.

8. The light control film of claim 1 or 2, wherein the second sections consist of optical fibers.

9. The light control film of claim 2, wherein the second sections comprise pillars having at least two regions, each of different opacity.

10. The light control film of claim 2, wherein the first matrix section is at least partially opaque.

11. The light control film of claim 1, wherein the matrix section comprises at least two regions, each of different opacity, that provides gradated opacity in the matrix section.

12. The light control film of claim 1 wherein the first matrix section is completely opaque.

13. The light control film of claim 1, wherein the second sections comprise pillars that are completely optically transparent.

14. The light control film of claim 1, wherein the first matrix section comprises at least two regions, each with different refractive indexes, such that the matrix region in contact with the second sections has a refractive index intermediary between the other matrix region and the refractive index of the second sections.

15. The light control film of claim 2, wherein the matrix section has a refractive index and the second section comprise pillars having at least two regions, each with different refractive indexes, such that the outermost region of pillar has a refractive index intermediary between the refractive index of the matrix section and the other second section region.

16. The light control film of claim 1, wherein the polymer material is selected from a group consisting of cellulose resin, polyolefin resin, polyester resin, polystyrene resin, polyurethane resin, polyvinylchloride resin, acryl resin and polycarbonate resin.

17. The light control film of claim 7, wherein the polymer fiber is prepared from a resin selected from a group consisting of cellulose resin, polyolefin resin, polyester resin, polystyrene resin, polyurethane resin, polyvinylchloride resin, acryl resin and polycarbonate resin.

18. The light control film of claim 8, wherein the optical fiber is selected from a group consisting of silicate-based, fluorine-based, rare earth element-based, plastic-based and plastic cladding optical fibers.

19-21. (canceled)

22. A process for manufacturing a light control film comprising the steps of:
(a) providing a curable matrix,
(b) immersing a plurality of a pillar type second section material into said matrix,
(c) curing said matrix, and
(d) skiving the resulting composite

23. The process of claim 22, wherein the plurality of pillar type second section material are coated with an optically opaque material before they are immersed into the matrix.

24. The process of claim 22, wherein the curable matrix is a polymer resin comprising an optically opaque material.

25. (canceled)
